(19) United States
(12) Patent Application Publication
(10) Pub. No.: US 2023/0415378 A1
(43) Pub. Date: Dec. 28, 2023

(54) ELECTROSPINNING OF EPOXY FIBERS

(71) Applicant: YEDA RESEARCH AND DEVELOPMENT CO. LTD., Rehovot (IL)

(72) Inventors: Daniel Hanoch WAGNER, Rehovot (IL); Mark SHNEIDER, Rehovot (IL)

(73) Assignee: YEDA RESEARCH AND DEVELOPMENT CO. LTD., Rehovot (IL)

(21) Appl. No.: 18/049,648

(22) Filed: Oct. 26, 2022

Related U.S. Application Data
(60) Provisional application No. 63/354,881, filed on Jun. 23, 2022.

(51) Int. Cl. B29B 7/00; B29B 7/10; D04H 1/728; D04H 1/4326; D01D 5/00

(52) U.S. Cl. CPC B29B 7/005; B29B 7/10; D01D 5/003; D04H 1/4326; D04H 1/728

(57) ABSTRACT

The presently disclosed subject matter relates to the field of electrospun epoxy fibers, a solution for producing the fibers and a system for electrospinning the fibers. This invention further relates to processes of producing the solution and the fibers. By dissolving epoxy in a dielectric solvent, suitable electrospinning conditions are achieved by controlling the degree of epoxy crosslinking in the solution. The fibers are captured on a net screen, with the positive electrode placed behind it. The resulting electrospun fibers exhibit superior mechanical properties in comparison with other epoxy fibers. This improvement in mechanical properties is, in part, due to anisotropic molecular rearrangement resulting from the strong stretching forces induced by electrospinning.

### FIELD OF THE INVENTION

The presently disclosed subject matter relates to the field of electrospun epoxy fibers, a solution for producing the fibers and a system for electrospinning the fibers. This invention further relates to processes of producing the solution and the fibers.

### BACKGROUND

Synthetic polymer fibers can be prepared by a number of routes including dry, wet, melt and gel spinning. Dry spinning involves the extrusion of fibers from a polymer solution that solidifies during solvent evaporation, whereas wet spinning is used when the solvent cannot be evaporated and must be removed by chemical means. Melt spinning uses heat to melt the polymer to a viscosity suitable for extrusion from a spinneret to generate fibers which solidify with cooling. Gel spinning is a preparation method for high-strength, high-modulus fibers. Following extrusion of the polymer solution or plasticized gel, cooling in solvent or water is applied before stretching to a gel fiber by ultra-high extension. During all these spinning processes, jets form under is external shearing forces and/or under mechanical drawing when passing through spinnerets. Fibers then form upon solidification of the jets. Stretched jets yield fibers with 10-100 μm diameters, typically, the sub-micron scale remaining difficult to get to.

By contrast, the technique known as electrospinning, which applies a strong electrostatic field to stretch a polymer solution, opens the door for the production of ultrathin fibers with diameters down to the nanometer scale. Extensive research has been dedicated to determining whether a particular solution is spinnable or not, indicating that a spinnable solution is one in which the forming jet is sufficiently stable, and the filament does not break up before drying. The solution composition is key to achieving processing stability by tuning a number of parameters, including solvent properties, polymer type and concentration. In addition to the dielectric solvent, which makes the solution electro-responsive, a suitable polymer molecular weight is a prerequisite for solution spinnability, ensuring that the solution is sufficiently viscous and highly contiguous. Therefore, the polymer system should be a percolating network, which is crucial in forming a continuous fiber. When a solution drop is exposed to an electric field with a higher force than its surface tension, it collapses and forms a Taylor cone, which further develops into an elongated jet. The entangled polymer chains prevent the elongated jet from breaking apart and forming droplets. Rapid evaporation of the solvent reduces the mobility of the chains within the jet and solidifies it to a fiber.

Thermoplastics are the most common polymer family used in electrospinning. By contrast, the other important group of polymers, the thermosetting polymers, has not been studied in electrospinning. Epoxy, the focus of the present invention, is of specific interest in view of its excellent mechanical properties and wide use as a matrix in composite materials. The main reason why electrospinning was never used with epoxy is its reactive nature and small oligomer molecule. When mixed with a curing agent, which is usually an amine-based molecule, it starts to kinetically crosslink such that with time and temperature the viscosity of the resin increases, and diffusion of the molecules is reduced until a rigid 3D covalently-bonded network is formed. The isothermal curing reaction of an epoxy resin is complex as a consequence of the interaction of the chemical curing reaction with other physical processes, such as gelation and vitrification, causing important changes in the macroscopic physical is properties of the reacting system.

For electrospinning purposes, this kind of network should be fluid enough to flow through a thin nozzle, collapse into a Taylor cone when exposed to an electric field, and capable of holding shear forces during the elongation in order to form a fiber. This evidently is a challenge with epoxy, in view of its native viscosity and bonding potential, and so a different approach than that used with thermoplastics must be considered.

Simpler mechanical drawing yielded epoxy fibers with diameters in the 10-200 μm range can be produced. These drawn fibers exhibit large plastic deformation of up to 150% in strain, and high strength at break and elastic modulus, compared to bulk epoxy which has brittle properties and a maximum strain of only 12% on average. Such unusual properties were attributed to re-arrangement of the molecular structure as a result of drawing. However, the small fiber diameters achievable by the drawing technique are limited. By comparison, because of its strong electrostatic stretching, electrospinning has the potential for achieving even thinner fibers and, possibly, much higher mechanical properties.

In the presently disclosed subject matter, thin epoxy fibers within a diameter range of 3-22 μm were prepared by electrospinning and examined. A new technique was developed to reach this diameter range, based on electrospinning of epoxy resin dissolved in a dielectric solvent. The strength, stiffness and effective toughness were measured in tension and correlated with the fiber diameter. Results are discussed and compared with those of mechanically drawn epoxy fibers, prepared with and without solvent.

### SUMMARY

The presently disclosed subject matter relates to the field of electrospun epoxy fibers, a solution for producing the fibers and a system for electrospinning the fibers. This invention further relates to processes of producing the solution and the fibers.

In one embodiment the presently disclosed subject matter provides a method of producing an electrospinning epoxy solution, the method comprises:
mixing an epoxy resin with an epoxy hardener, producing an epoxy;
adding a dielectric solvent to the epoxy, producing an epoxy solution; and
stirring and/or heating the epoxy solution to produce an electrospinning epoxy solution.

In one embodiment the presently disclosed subject matter provides a method of producing an electrospinning epoxy solution, the method comprises:
mixing an epoxy resin with an epoxy hardener, producing an epoxy;
adding a dielectric solvent to the epoxy, producing an epoxy solution; and
stirring and heating the epoxy solution to produce an electrospinning epoxy solution.

In one embodiment the presently disclosed subject matter provides a method of producing an electrospinning epoxy solution, the method comprises:
mixing an epoxy resin with an epoxy hardener, producing an epoxy;
adding a dielectric solvent to the epoxy, producing an epoxy solution; and
stirring or heating the epoxy solution to produce an electrospinning epoxy solution.

In one embodiment of the method the dielectric solvent comprises methyl ethyl ketone (MEK), dimethylformamide (DMF), tetrahydrofuran (THF) or any combination thereof. In one embodiment of the method the weight fraction of the dielectric solvent ranges between 50%-99% of the total solution weight.

In one embodiment of the method the stirring comprises a first stage and a second stage, wherein:
the stirring rate of the first stage is higher than the stirring rate of the second stage; and/or
the duration of stirring in the first stage is shorter than the duration of the stirring in the second stage; and/or
the temperature of the epoxy solution during the first stage is lower than the temperature of the epoxy solution during the second stage.

In one embodiment of the method the stirring comprises a first stage and a second stage, wherein:
the stirring rate of the first stage is higher than the stirring rate of the second stage, or
the duration of stirring in the first stage is shorter than the duration of the stirring in the second stage; or
the temperature of the epoxy solution during the first stage is lower than the temperature of the epoxy solution during the second stage; or any combination thereof.

In one embodiment of the method the stirring comprises a first stage and a is second stage, wherein:
the stirring rate of the first stage is higher than the stirring rate of the second stage, and
the duration of stirring in the first stage is shorter than the duration of the stirring in the second stage.

In one embodiment of the method the stirring comprises a first stage and a second stage, wherein:
the stirring rate of the first stage is higher than the stirring rate of the second stage; and
the temperature of the epoxy solution during the first stage is lower than the temperature of the epoxy solution during the second stage.

In one embodiment of the method the stirring comprises a first stage and a second stage, wherein:
the duration of stirring in the first stage is shorter than the duration of the stirring in the second stage; and
the temperature of the epoxy solution during the first stage is lower than the temperature of the epoxy solution during the second stage.

In one embodiment of the method the stirring comprises a first stage and a second stage, wherein:
the stirring rate of the first stage is higher than the stirring rate of the second stage; and
the temperature of the epoxy solution during the first stage is lower than the temperature of the epoxy solution during the second stage.

In one embodiment of the method the stirring rate of the first stage ranges between 500 to 2000 rpm and the stirring rate of the second stage ranges between 100-500 rpm. In one embodiment of the method the duration of stirring in the first stage ranges between 1 minute to 1 hour and the duration of stirring in the second stage ranges between 1 hour and 15 days. In one embodiment of the method the temperature during the first stage is about room temperature and wherein the temperature during the second stage ranges between 50-150° C.

In one embodiment of the method the stirring stops when the epoxy solution reaches a state between early gelation and vitrification, producing an electrospinning epoxy solution.

In one embodiment the presently disclosed subject matter provides an electrospinning solution produced by any one of the methods described herein. In one embodiment the electrospinning solution comprises: an epoxy resin, an epoxy hardener and a dielectric solvent. In one embodiment the electrospinning solution consists of: an epoxy resin, an epoxy hardener and a dielectric solvent. In one embodiment the electrospinning solution comprises: an epoxy resin, an epoxy hardener, a dielectric solvent and at least one other solvent. In one embodiment the electrospinning solution comprises: at least one epoxy resin, at least one epoxy hardener and at least one dielectric solvent.

In one embodiment, this invention provides a system for electrospinning epoxy fibers, said system comprising:
a syringe barrel, said barrel being at least partially filled with an electrospinning epoxy solution as described herein;
an electrically grounded nozzle;
a needle;
a syringe pump for feeding said electrospinning epoxy solution out of said needle;
a fiber collector;
an electrode positioned behind said fiber collector; and
a power supply;
wherein said syringe pump is configured to eject said electrospinning epoxy solution from said needle when applying a voltage between said nozzle and said electrode, producing epoxy fibers which collect on said fiber collector.

In one embodiment the presently disclosed subject provides a system for electrospinning epoxy fibers, comprising:
a syringe pump comprising a syringe barrel, the barrel being at least partially filled with the electrospinning epoxy solution described herein, an electrically grounded nozzle, a needle and a means to feed the electrospinning epoxy solution out of the needle,
a fiber collector;
an electrode positioned behind the fiber collector; and
a power supply;
wherein the syringe pump is configured to eject the electrospinning epoxy solution from the needle when applying a voltage between the nozzle and the electrode, producing epoxy fibers which collect on the fiber collector. In one embodiment of the system the inner diameter of the needle ranges between 0.5 to 1 mm. In one embodiment of the system the fiber collector is made of a metal mesh. In one embodiment of the system the distance from the nozzle to the fiber collector ranges between 5 to 30 cm and the distance from the fiber collector to the electrode ranges between 0.5 to 10 cm.

In one embodiment, this invention provides a method of producing epoxy fibers, said method comprising:
providing a system as described herein;
applying a voltage between said grounded nozzle and said electrode resulting in said electrospinning epoxy solution exiting through said nozzle producing an airborne jet which lands on said fiber collector producing epoxy fibers.

In one embodiment the presently disclosed subject matter provides a method of producing epoxy fibers, the method comprises:
providing a system for electrospinning epoxy fibers;
wherein a voltage is applied between the grounded nozzle and the electrode resulting in the electrospinning epoxy solution exiting through the nozzle producing an airborne jet which lands on the fiber collector producing epoxy fibers

In one embodiment of the method the feed rate of the electrospinning epoxy solution ranges between 0.1 to 10 ml/hr. In one embodiment of the method the applied voltage ranges between 1 to 30 kV.

In one embodiment of the method, the method further comprises curing the epoxy fibers, wherein the curing comprises:
leaving the epoxy fibers to rest for a duration of between 1 to 24 hrs after they are produced;
placing the epoxy fibers under vacuum for a duration of between 24 to 72 hrs; placing the epoxy fibers in an oven at a temperature of between 50 to 200° C. for between 1 to 10 hrs;
or any combination thereof.

In one embodiment the presently disclosed subject matter provides an epoxy fiber produced by any one of the methods described herein.

In one embodiment the electrospun epoxy fiber comprises: an epoxy resin is and an epoxy hardener. In one embodiment the electrospun epoxy fiber consists of: an epoxy resin and an epoxy hardener.

In one embodiment of the electrospun epoxy fiber the diameter of the electrospun epoxy fiber ranges between about 200 nm to 25 μm. In one embodiment of the electrospun epoxy fiber the length of the electrospun epoxy fiber ranges between 1 mm and 10 m. In one embodiment of the electrospun epoxy fiber the strength of the electrospun epoxy fiber ranges between 50 to 350 MPa. In one embodiment of the electrospun epoxy fiber the maximum strain of the electrospun epoxy fiber ranges between 80 to 130%. In one embodiment of the electrospun epoxy fiber the Young's Modulus of the electrospun epoxy fiber ranges between 1000 to 3500 MPa. In one embodiment of the electrospun epoxy fiber the effective toughness of the electrospun epoxy fiber ranges between 25 to 200 MP.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 is a picture of the electrospinning system. The nozzle to screen distance is 19 cm, and the electrode is positioned 1 cm behind the screen.

FIG. 2A shows an illustration of a Taylor cone for thermoplastic and FIG. 2B shows an illustration of a Taylor cone for thermosetting solutions in electrospinning; FIG. 2C shows a schematic time temperature transformation (TTT) cure diagram; the grey curve represents the haziness transition. The indicated dots are: (a) The first observation of gelation in epoxy/MEK solution at 70° C. curing temperature (T_{cure}*), (b) The appearance of haziness in the solution at day 7, in one embodiment, of mixing and heating, (c) The solution reaches the sol/gel glassy state.

FIG. 3A shows the epoxy solution for electrospinning: the left bottle is a clear transparent solution just prepared and the right bottle is the hazy solution ready to use after 7 days of mixing and heating, in one example; FIG. 3B shows electrospun epoxy fibers deposited on an aluminum net (strong light was projected to observe the fibers without magnification); FIG. 3C shows a tensile specimen (the left bridge is cut prior to testing); FIG. 3D shows an SEM micrograph of a single electrospun fiber.

FIG. 4 shows a differential scanning calorimetry (DSC) thermogram of electrospun epoxy fibers and bulk epoxy.

FIG. 5 shows tensile test results on electrospun epoxy fibers with a diameter of 3-21 μm: Figure SA shows the engineering strength versus fiber diameter;

FIG. 5B shows the maximum strain versus fiber diameter; FIG. 5C shows the Young's Modulus versus fiber diameter; FIG. 5D shows the effective toughness versus fiber diameter (calculated as the area under the stress-strain curve).

FIG. 6 shows SEM micrographs of electrospun epoxy fibers after a tensile test: FIG. 6A shows the necking regions; FIG. 6B shows the cross section of the fiber surface after fracture, exhibiting a rough surface with a plastically deformed cylindrical layer surrounding the fiber core (inset shows the plastic deformation region with greater image contrast).

FIG. 7 shows a comparison between electrospun fibers and mechanically drawn fibers: FIG. 7A shows stress-strain curves of a representative epoxy bulk and three types of fibers; FIG. 7B shows strength against diameter of fibers electrospun from solution of epoxy with MEK solvent, and of mechanically drawn fibers with and without solvent. The trend lines are power functions fitted to the data (see details disclosed hereinafter).

FIG. 8 shows UV-Visible spectra of the electrospinning solution. Fresh solution reached total absorbance at wavelength of 315 nm compared to 323 nm for the electrospinning solution.

For simplicity and clarity of illustration, elements shown in the figures are not necessarily drawn to scale, and the dimensions of some elements may be exaggerated relative to other elements. In addition, reference numerals may be repeated among the figures to indicate corresponding or analogous elements.

### DETAILED DESCRIPTION

Achieving the Electrospinning of Epoxy Fibers

Electrospinning of epoxy is a challenging task, both in preparing the solution and in conducting the process. To understand the reasons for preparing the solution as described herein, it is important to appreciate the differences between thermosetting and thermoplastic polymers in the context of electrospinning. This is described in Table 1:

TABLE 1
Differences between thermoplastic and thermosetting
polymers with respect to electrospinning.

| Property | Thermoplastic polymer | Thermosetting polymer |
|---|---|---|
| Raw material | Solid | Liquid |
| Components | Polymer | Polymer and curing agent |
| Molecular weight, Mw | Can reach high Mw | Low Mw, ~1000 |
| | | kilodalton (kDa) |
| Morphology in soluble state | Linear or branched polymer | Oligomers |
| | chains | |
| Viscosity in soluble state | Dependent on concentration | Increases as the cross-linking |
| | | reaction proceeds |
| Molecular morphology in the | Amorphous or crystalline | Cross-linked network |
| bulk | | |
| Thermal properties - glass | Tg and Tm | Only Tg |
| Transition and melting | | |
| temperatures | | |
| Molecular interaction in dry | Chain entanglements, dipole | Covalently bonded 3D network |
| state | and hydrogen bonds | |

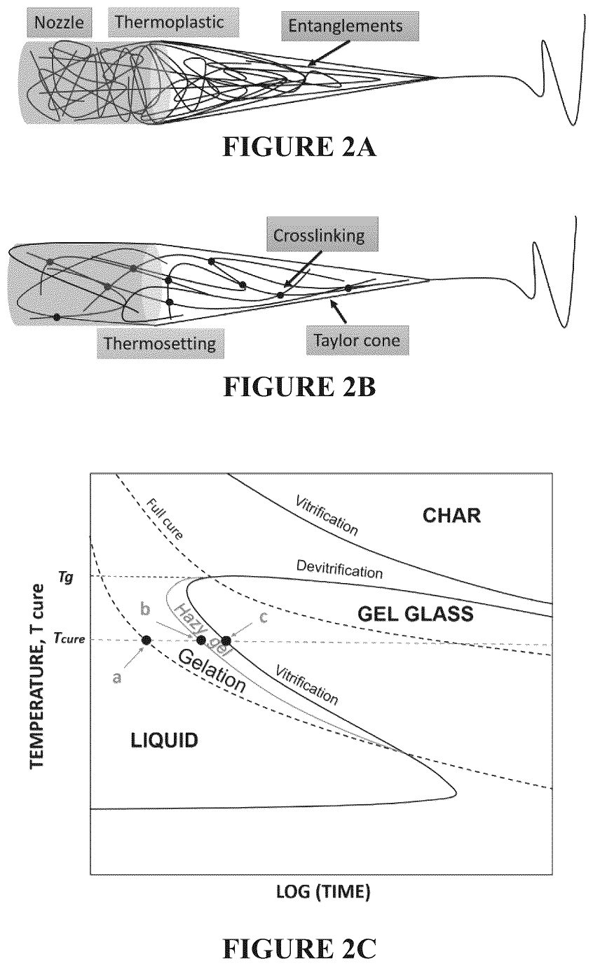

As described in the Background section, to forma Taylor cone, the molecules in the solution should be mechanically or chemically linked to each other. In thermoplastics, this linking is achieved by the topological entanglement of the long chains with each other. By contrast, in the case of epoxy, which has relatively short molecules, the crosslinking reaction forms the linkage needed for electrospinning. The approach taken herein is to control the degree of crosslinking and thus achieve a solution that will form a 3D percolated network, identified as the early gelation state in one embodiment. This kind of network is soft enough to flow through a thin nozzle, and collapse into a Taylor cone when exposed to the electric field, and at the same time strong enough to be able to sustain the tension and shear forces during the elongation in order to form a fiber (FIG. 2A and FIG. 2B).

A goal of the present invention is to produce epoxy fibers by electrospinning. As used herein “electrospinning” refers to methods of producing fibers (e.g., epoxy fibers) from a liquid or solution (e.g., an epoxy solution) using an electric field and a corresponding electric force. As used herein, “epoxy” refers herein to epoxy resin derived by polymerization from epoxides. Epoxies or epoxy resin may be reacted (also referred to herein as “cross-linked”) either with themselves through catalytic homo-polymerization, or with a wide range of co-reactants. In some embodiments, the co-reactants comprise polyfunctional amines, acids (and acid anhydrides), phenols, alcohols and thiols (e.g., mercaptans).

As used herein, and in some embodiments, the terms “hardeners”, “co-reactants”, “curatives” or “curing agents” are used interchangeably. In one embodiment, any epoxy material which undergoes cross-linking and/or thermosetting can be used for producing epoxy fibers by electrospinning. For the purpose of example alone, the epoxy resin is selected from the group comprising, but not limited to: bisphenol-based resins, novolaks-based resins, aliphatic-based resins, halogenated resins, glycidylamine-based resins or combinations thereof. As such, and in some embodiments any number of hardeners can be used, comprised within the epoxy solution. Without being bound by theory, any epoxy resin and corresponding hardener can be used for producing epoxy fibers by electrospinning. As such, and in some embodiments, the optimal ratio and/or volume and/or weight between resin, hardener and solvent can be selected in order to produce an epoxy solution that is suitable for electrospinning to produce epoxy fibers of this invention. In one embodiment the epoxy solution further comprises nanotubes. In one embodiment the epoxy solution further comprises carbon nanotubes. In one embodiment the epoxy solution does not comprise nanotubes. In one embodiment the epoxy solution does not comprise carbon nanotubes.

In some embodiments any number of the following parameters are optimized for the epoxy solution, for use in electrospinning of epoxy fibers, and will vary according to the specific epoxy solution composition, all of which are considered for the present invention: viscosity, concentration, molecular weight, surface tension of the solution at the end of the needle and/or nozzle, conductivity or polarizability of the solution.

In one embodiment, the first step in preparing the solution is to mix epoxy resin, epoxy hardener and dielectric solvent until reaching homogeneity. As used herein “epoxy solution” refers to any solution comprising an epoxy resin (also referred to herein as “resin”), epoxy hardener (also referred to herein as “hardener”) and a solvent. In one embodiment the epoxy solution consists of an epoxy resin, an epoxy hardener and a solvent. In one embodiment the epoxy solution comprises at least one epoxy resin, at least one epoxy hardener and at least one solvent.

In one embodiment the solvent is a dielectric solvent. In some embodiments the term “solvent” is interchangeable with the term “dielectric solvent”. In some embodiments, the dielectric solvent is methyl ethyl ketone (MEK), dimethylformamide (DMF), tetrahydrofuran (THF) or any combination thereof. In some embodiments, the dielectric solvent is selected from methyl ethyl ketone (MEK), dimethylformamide (DMF), tetrahydrofuran (THF) or any combination thereof. In one embodiment the dielectric solvent comprises about 50% of the total solution weight. In one embodiment the dielectric solvent comprises about 60% of the total solution weight. In one embodiment the dielectric solvent comprises about 70% of the total solution weight. In one embodiment the dielectric solvent comprises about 80% of the total solution weight. In one embodiment the dielectric solvent comprises about 90% of the total solution weight. In some embodiments the dielectric solvent has a weight fraction ranging between 50% to 99% of the total solution weight. In some embodiments the dielectric solvent has a weight fraction ranging between 60% to 99% of the total solution weight. In some embodiments the dielectric solvent has a weight fraction ranging between 70% to 99% of the total solution weight. In some embodiments the dielectric solvent has a weight fraction ranging between 80% to 99% of the total solution weight. In some embodiments the dielectric solvent has a weight fraction ranging between 50% to 60% of the total solution weight. In some embodiments the dielectric solvent has a weight fraction ranging between 60% to 70% of the total solution weight. In some embodiments the dielectric solvent has a weight fraction ranging between 70% to 80% of the total solution weight. In some embodiments the dielectric solvent has a weight fraction ranging between 80 to 90% of the total solution weight. In some embodiments the dielectric solvent has a weight fraction ranging between 90% to 99% of the total solution weight. In some embodiments the dielectric solvent has a weight fraction of about 70% of the total solution weight.

In one embodiment any dielectric solvent which results in homogenous mixing of an epoxy can be used. In one embodiment the epoxy is stirred with a solvent to produce an electrospinning epoxy solution. In one embodiment the epoxy is stirred with a solvent, at a raised temperature, to produce an electrospinning epoxy solution. In some embodiments the epoxy solution comprises at least one dielectric solvent. In some embodiments the homogeneity of the epoxy solution, in a first stage, is achieved by applying a high mixing rate. In one embodiment the mixing is carried out by magnetic stirring (with an associated stirring rate). In one embodiment the mixing is carried out in a conditioning mixer. In some embodiments, the terms “high” or “higher” and “low” or “lower” are relative terms to compare the mixing rates of different stages of mixing e.g., the first and second stage of mixing of an epoxy solution.

In some embodiments, the stirring rate of the first stage in mixing the epoxy solution ranges between 100-2000 rpm. In some embodiments, the stirring rate of the first stage in mixing the epoxy solution ranges between 100-500 rpm. In some embodiments, the stirring rate of the first stage in mixing the epoxy solution ranges between 500-1000 rpm. In some embodiments, the stirring rate of the first stage in mixing the epoxy solution ranges between 1000-1500 rpm. In some embodiments, the stirring rate of the first stage in mixing the epoxy solution ranges between 1000-2000 rpm. In some embodiments, the stirring rate of the first stage in mixing the epoxy solution ranges between 1500-2000 rpm.

In one embodiment the duration of the first stage of mixing ranges between 1 minute and 10 minutes. In one embodiment the duration of the first stage of mixing ranges between 10 minutes and 20 minutes. In one embodiment the duration of the first stage of mixing ranges between 20 minutes and 30 minutes. In one embodiment the duration of the first stage of mixing ranges between 30 minutes and 60 minutes.

In some embodiments the first stage of mixing is carried out at an elevated temperature. In one embodiment, “elevated temperature” is a temperature above room temperature. As used herein “room temperature” is about 15° C. to 25° C. In one embodiment the first stage of mixing is carried out at a temperature ranging between 25° C. to 50° C. In one embodiment the first stage of mixing is carried out at a temperature ranging between 50° C. to 100° C.

As will be shown herein, the resulting epoxy solution is electro-responsive in order to obtain epoxy fibers by electrospinning. As used herein “electro-responsive” refers to a material that responds to an applied electric field i.e., it moves as a result of an applied voltage. Therefore, any epoxy solution that is electro-responsive is considered for the present invention, in some embodiments. An expert in the art will understand that epoxy solutions comprised of different material components (e.g., any number of resins, hardeners and solvents) may require optimization for each combination of materials since they will result in different physical and chemical properties such as viscosity, concentration, rate of cross-linking, etc. all of which are considered within the scope of the present invention.

In some embodiments, the second step in preparing the epoxy solution is to apply a lower mixing rate in comparison to the mixing rate in the first stage. In some embodiments, the stirring rate of the second stage in mixing the epoxy solution ranges between 1-100 rpm. In some embodiments, the stirring rate of the second stage in mixing the epoxy solution ranges between 1-50 rpm. In some embodiments, the stirring rate of the second stage in mixing the epoxy solution ranges between 50-100 rpm. In some embodiments, the stirring rate of the second stage in mixing the epoxy solution ranges between 100-200 rpm. In some embodiments, the stirring rate of the second stage in mixing the epoxy solution ranges between 150-200 rpm. In some embodiments, the stirring rate of the second stage in mixing the epoxy solution ranges between 200-300 rpm. In some embodiments, the stirring rate of the second stage in mixing the epoxy solution ranges between 200-250 rpm. In some embodiments, the stirring rate of the second stage in mixing the epoxy solution ranges between 250-300 rpm. In some embodiments, the stirring rate of the second stage in mixing the epoxy solution ranges between 300-500 rpm. In some embodiments, the stirring rate of the second stage in mixing the epoxy solution ranges between 500-1000 rpm.

In some embodiments the second stage in mixing is carried out at an elevated temperature. In some embodiments the second stage of mixing is carried out at a temperature ranging between 50 to 100° C. In some embodiments the second stage of mixing is carried out at a temperature ranging between 50 to 80° C. In some embodiments the second stage of mixing is carried out at a temperature ranging between 80 to 100° C. In some embodiments the second stage of mixing is carried out at about 70° C. In some embodiments the second stage of mixing is carried out at a temperature ranging between 100° C. to 150° C. The selected temperature of the second stage of mixing will depend on the resin, hardener and solvent that is chosen to produce the epoxy solution. Thus, in one embodiment, an epoxy solution will not require a raised or elevated temperature during mixing.

In one embodiment the duration of the second stage of mixing ranges between 2 to 24 hrs. In one embodiment the duration of the second stage of mixing ranges between 24 to 48 hrs. In one embodiment the duration of the second stage of mixing ranges between 48 to 62 hrs. In one embodiment the duration of the second stage of mixing ranges between 62 to 76 hours. In one embodiment the duration of the second stage of mixing is about 76 hours. The selected duration of the second stage of mixing will depend on the resin, hardener and solvent that is chosen to produce the epoxy solution. As will become clear, and in one embodiment, the completion of the second stage of mixing requires the appearance of haziness in the epoxy solution, which can change depending on the composition of the epoxy solution. In some compositions of epoxy solution the solution becoming hazy is an indication of it being ready for electrospinning.

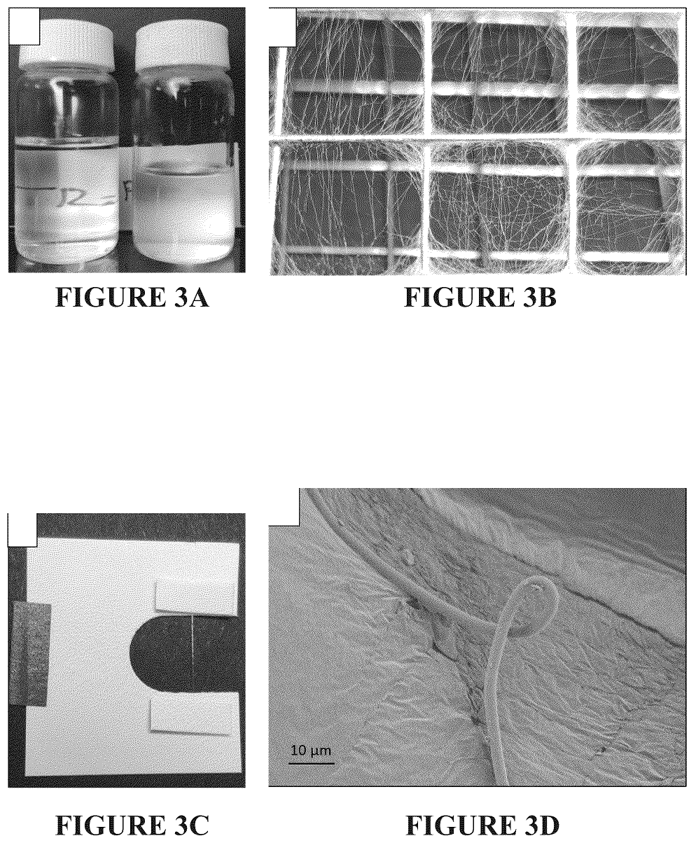

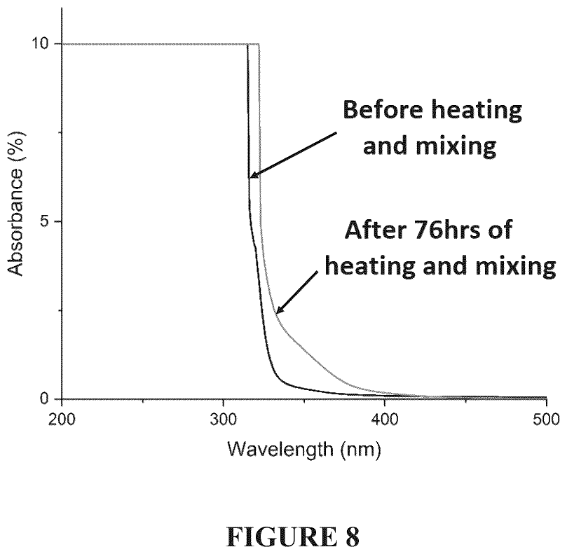

Without being bound by theory, as the epoxy and the hardener are being mixed on the hot plate, the crosslinking reaction starts but at a low rate, as a result of the high fraction of solvent, which reduces the probability of the epoxy molecules meeting each other. As the mixing proceeds with time, the viscosity builds up until it reaches the gelation state (see FIG. 2C). At that point, the solution loses its fluidity, which indicates the joining of the epoxy branched molecules into a 3D network, but with a low degree of crosslinking. The mixing of the solution continues until a slight haziness appears, and, at that point, the epoxy crosslinking degree is sufficient for electrospinning. It is important to reach this haziness as an indicator for a specific density of crosslinking. Indeed, during fiber formation, the elongated jet will be able to sustain the extension forces by its covalent crosslinked bonds and will not break into drops, an effect that does happen with a solution that is not sufficiently gelated. In one embodiment, the epoxy solution is ready for use in electrospinning when it becomes hazy. As used herein the terms “hazy” and “haziness” refer to a solution which has become translucent i.e., it is no longer transparent. In another embodiment, the terms “hazy” and “haziness” refer to a solution which has become opaque. In one embodiment, the epoxy solution starts off transparent and turns hazy after mixing. In one embodiment, the epoxy solution starts off translucent and becomes more opaque after mixing. In one embodiment, the epoxy solution starts off transparent and becomes opaque after mixing. FIG. 8 shows UV-visible spectra comparing fresh solution which reached a total absorbance at wavelength of 315 nm compared to 323 nm for the electrospinning solution which had become hazy. As used herein, and in one embodiment, “electrospinning solution” or “electrospinning epoxy solution” refers to an epoxy solution which is ready for use in electrospinning. In one embodiment, “electrospinning solution” and “electrospinning epoxy solution” are used interchangeably. Using a UV-visible spectra is one way of characterizing when an epoxy solution has become hazy and ready for use in electrospinning. FIG. 3A shows one such example of an epoxy solution which has become hazy after mixing at raised temperature for 7 days (see right bottle) versus a transparent solution prior to be being is mixed at a raised temperature (see left bottle). In one embodiment, the haziness of an epoxy solution can be determined by the visual perception of a user. In one embodiment, when the epoxy solution changes phase it is ready for use in electrospinning. In one embodiment, when the epoxy solution changes color it is ready for use in electrospinning. It should be noted that not all epoxy solutions will turn hazy as an indication for readiness in use in electrospinning. Any number of changes may occur in an epoxy solution to indicate when the epoxy solution is ready for electrospinning. However, in one embodiment, haziness is an indication that sufficient cross-linking has occurred to ensure that the epoxy solution can be successfully electrospinned into epoxy fibers. In another embodiment, haziness is not an indication that the epoxy solution is ready for electrospinning. According to this aspect and in one embodiment, a transparent epoxy solution is used for electrospinning. According to this aspect and in one embodiment, a non-hazy epoxy solution is used for electrospinning.

Without being bound by theory, in order to better point the exact time at which the solution is ready to use, a schematic time temperature transformation (TTT) diagram is used (FIG. 2C). The TTT diagram presents the various stages the solution passes through, from the liquid state to solid state, with dependence on temperature and time. As described previously, the solution reaches the gelation state (point ‘a’ in FIG. 2C) and as mixing continues, it slowly moves toward the vitrification region. As it gets closer to the vitrification border (point ‘c’ in FIG. 2C), the solution starts to lose its transparency (point ‘b’ in FIG. 2C), which is expressed by the haziness (FIG. 3A). At that stage, the solution is either in the gelation state or is in early vitrification.

It is important to note that the TTT diagram depicted in FIG. 2C shows the various stages that the epoxy solution can pass through. From approximately between the early gelation state to the vitrification state the epoxy solution is considered ready for electrospinning depending on the composition of the epoxy solution. In one embodiment the epoxy solution is ready for electrospinning when it is in a state between the gelation state and the vitrification state. In one embodiment the epoxy solution is ready for electrospinning when it is in a state approximately between the gelation state and the vitrification state. Some epoxy solutions exhibit haziness as an indication of readiness for electrospinning, however, the presently disclosed subject matter is not bound to this. Indeed, in some embodiments, the haziness of the epoxy solution is anywhere within the gelation and vitrification state shown in FIG. 2C, i.e., not specifically in the “hazy gel” region depicted FIG. 2C. In some embodiments, the epoxy solution is heated to provide faster cross-linking to reach the viscosity required for electrospinning. In some embodiments, this is shown as haziness. In some embodiments, the epoxy solution is ready for electrospinning when it is in the early gelation state. “Early gelation” refers to a state before gelation, or at the early stages of gelation, and wherein the epoxy solution is undergoing processes such as stirring and heating, or stirring, or heating, which pushes the epoxy solution closer towards gelation. In some embodiments “early gelation” and “pre gelation” are used interchangeably. In one embodiment the epoxy solution is ready for electrospinning before the gelation state.

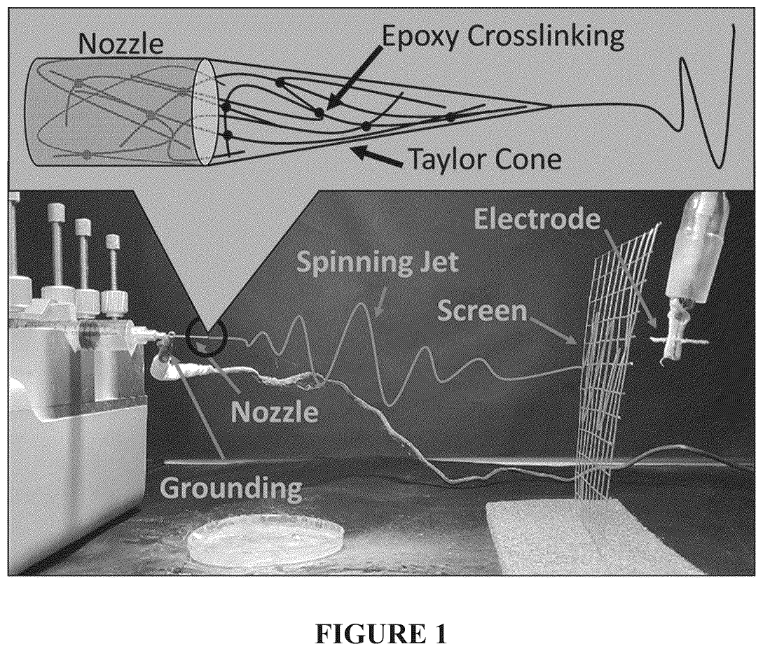

To achieve successful electrospinning of epoxy fibers, some aspects of the epoxy solution and the characteristics of the electrospun fibers should be taken in account. When haziness appears and the solution is ready to use, it continues to crosslink with time; a reduction in temperature or an increase in mixing speed will reduce the crosslinking rate and enable better control on the solution. In some embodiments, the method of preparing the epoxy solution further comprises reducing the temperature or reducing the mixing rate of the epoxy solution after the second stage of mixing. In some embodiments, the method of preparing the epoxy solution further comprises reducing the temperature and reducing the mixing rate of the epoxy solution after the second stage of mixing. During electrospinning, as the solution flows out from the nozzle, it is stretched, the solvent evaporates and the fiber is formed. At that point, the fiber is flying to the collector but still contains some solvent while in the process of crosslinking. The spinning speed depends on numerous factors, for example: viscosity of the epoxy solution, the feeding rate, solution flow rate, nozzle diameter, distance to the electrode and net, applied voltage, the temperature, the humidity, etc. Electrospinning, to produce epoxy fibers will be optimized for each epoxy solution depending on its composition. The spinning process is very fast, of the order of 100 msec, in one embodiment, from nozzle to collector, thus there is no sufficient time for cross-linking during the free flight. In one embodiment the time of flight of a jet of epoxy solution, from nozzle to collector ranges between 1 ms to 100 ms. In one embodiment the time of flight of a jet of epoxy solution, from nozzle to collector ranges between 10 ms to 100 ms. In one embodiment the time of flight of a jet of epoxy solution, from nozzle to collector ranges between 10 ms to 500 ms. In one embodiment, the time of flight of a jet of epoxy solution, from nozzle to collector, is any time that is shorter is than the time for cross-linking to occur. At the same time, the very rapid solvent evaporation brings the epoxy units closer together and allows faster curing once the fiber reaches the collector. At this state, the fiber has become tacky, and to collect a single fiber for a tensile test, the fiber must be deposited on a hollow frame, left to dry and continue crosslinking at room temperature. In one embodiment the epoxy fiber, when it reaches the collector, is sticky or adhesive. In one embodiment the epoxy fiber, when it reaches the collector, is not sticky or adhesive. For this purpose, and in one embodiment, a system based on grounding the nozzle and applying voltage on a copper rod (electrode) placed behind the collector was devised (FIG. 1). The objective is to make the fiber fly toward the electrode but collect it on an aluminum net just before it reaches the electrode. In one embodiment, the nozzle is charged. In one embodiment the nozzle is grounded. During the process optimization, which includes tuning of the solution flow rate, electric field, nozzle diameter, and electrode and net distances, fibers were collected on a transparent glass and analyzed by means of optical microscopy. The main optimization procedure was to overcome bead formation and achieve neat fiber as showed in FIGS. 3B and 3C. Generally, as the viscosity of the solution increased, the amount of beads was reduced.

In one embodiment, this invention is directed towards a system for electrospinning an epoxy solution, an embodiment of which is shown in FIG. 1. The system is used to produce epoxy fibers by electrospinning.

In one embodiment, this invention provides a system for electrospinning epoxy fibers, said system comprising:
a syringe barrel, said barrel being at least partially filled with an electrospinning epoxy solution as described herein;
an electrically grounded nozzle;
a needle;
a syringe pump for feeding said electrospinning epoxy solution out of said needle;
a fiber collector;
an electrode positioned behind said fiber collector; and
a power supply;
wherein said syringe pump is configured to eject said electrospinning epoxy solution from said needle when applying a voltage between said nozzle and said electrode, producing epoxy fibers which collect on said fiber collector.

The presently disclosed subject matter is also directed towards a system for electrospinning an epoxy solution, an embodiment of which is shown in FIG. 1. The system is used to produce epoxy fibers by electrospinning. In one embodiment the system comprises:
a syringe pump comprising a syringe barrel, said barrel being at least partially filled with any one of the epoxy solutions disclosed herein, in particular one that is ready for electrospinning, an electrically grounded nozzle, a needle and a means to feed said epoxy solution out of said needle;
a fiber collector;
an electrode positioned behind the fiber collector; and
a power supply;
wherein the syringe pump is configured to eject the epoxy solution from said needle, producing epoxy fibers which collect on said fiber collector, by an applied voltage between said nozzle and said electrode.

All of the physical parameters of the electrospinning system must be optimized for a particular epoxy solution. In order to produce a jet of epoxy solution ejected from the nozzle or needle a number of parameters must be considered such as the viscosity of the solution, the diameter of the nozzle or needle, length of the needle, the applied voltage, the distance between the nozzle or needle and the fiber collector, the distance between the fiber collector and the electrode behind said fiber collector. In one embodiment the epoxy solution is fed through the needle by an automated motor or syringe pump which controls the feed rate of the solution. In some embodiments the nozzle and the needle are attached. In one embodiment the nozzle and the needle are the same.

As used herein “feed rate” refers to the volume of liquid that passes through the syringe, needle or nozzle in a certain amount of time. In one embodiment the phrases “feed rate” and “flow rate” are interchangeable. In one embodiment the feed rate ranges between 0.1 to 10 ml/hr. In one embodiment the feed rate ranges between 0.1 to 1 ml/hr. In one embodiment the feed rate ranges between 0.5 to 1 ml/hr. In one embodiment the feed rate ranges between 1 to 2 ml/hr. In one embodiment the feed rate ranges between 2 to 10 ml/hr. In one embodiment the feed rate is about 0.6 ml/hr. In one embodiment the feed rate is about 0.7 ml/hr. In one embodiment the feed rate is about 0.8 ml/hr.

In one embodiment the fiber collector is made of metal. In one embodiment the fiber collector is made of a metal alloy. In one embodiment the fiber collector is a metal mesh. In one embodiment the fiber collector is made of any of the following selected from a group comprising: aluminum, copper, tin, iron, steel, zinc, nickel and stainless steel. In one embodiment the fiber collector comprises plastic. In one embodiment the fiber collector is electrically detached from the electrode behind it. In one embodiment there is more than one electrode behind the fiber collector. In one embodiment the fiber collector has a 15×15 mm² cell size. In one embodiment the fiber collector has a 20×20 mm² cell size. The cell refers to a structural element, such as a frame, in the collector upon which epoxy fibers are suspended across. In one embodiment, the cell size ranges between 10×10 mm² and 30×30 mm². FIG. 3B shows a number of such cells with epoxy fibers suspended across them.

The resulting epoxy fibers can take on a number of different forms. For example, the epoxy fibers collected on the fiber collector can comprise individual fibers, bundles or sheets. The density of epoxy fibers on the epoxy fiber sheet can be readily optimized depending on how much epoxy solution is used in one session of electrospinning i.e., using more epoxy solution will produce more epoxy fibers and hence a denser sheet, or mat, of epoxy fibers. The thickness of such a mat can also be prepared according to how long the electrospinning solution occurs for and how much epoxy solution is used. In one embodiment, the electrospun epoxy fibers produces a sheet of epoxy fibers. In one embodiment, the electrospun epoxy fibers produces a bundle of epoxy fibers. In some embodiments, multiple sheets of electrospun epoxy fibers can be electrospun on top of each other. In other embodiments, epoxy solutions of differing compositions can be used together to make composites of epoxy fiber sheets or mats. In some embodiments, the fiber collector can be moved, for example on a conveyor belt, to produce longer sheets. In such an example, the sheet of epoxy fibers is being continuously produced on a fiber collector that is moving. In another embodiment, the epoxy fibers are electrospun into a yarn. In one embodiment the epoxy fibers do not comprise nanotubes. In one embodiment the epoxy fibers do not comprise carbon nanotubes.

In one embodiment the needle has any end shape e.g., flat, bevel or other. In one embodiment the term “nozzle” and “needle” are used interchangeably. In one embodiment the inner diameter of the needle ranges between 0.5 mm to 1 mm. In one embodiment the inner diameter of the needle ranges between 0.6 to 0.7 mm In one embodiment the inner diameter of the needle ranges between 0.7 to 0.8 mm In one embodiment the inner diameter of the needle ranges between 0.7 to 0.9 mm. In one embodiment the inner diameter of the needle ranges between 0.9 to 1.0 mm.

In some embodiments electrode is made of any metal. In one embodiment the electrode comprises copper. In one embodiment the electrode is positioned centrally behind the fiber collector. In one embodiment the electrode is positioned 10 mm behind the fiber collector. In some embodiments the terms “fiber collector”, “net”, “metal net” and “screen” are used interchangeably. As used herein the term “jet” refers to the solution that is ejected from the nozzle or needle. As used herein the term “jet”, “epoxy jet” and “ejected epoxy solution”, and the likes, are used interchangeably. As will become clear, this jet forms the basis of the formation of epoxy fibers.

In one embodiment the syringe comprises a plunger, a barrel, a needle adapter, a nozzle, a nozzle hub and a shaft or needle. In one embodiment the syringe comprises a Luer lock. In one embodiment the barrel is any container or vessel which holds liquid in the syringe. In one embodiment the barrel is connected to the nozzle. In one embodiment the barrel is connected to the needle in one embodiment the barrel is attached to the nozzle and wherein the needle is attached to the nozzle. In one embodiment a means to feed epoxy solution out of the needle or nozzle is connected to the syringe, in any one of its parts e.g., to the plunger, barrel, etc. in one embodiment the means to feed the epoxy solution is a syringe pump. In one embodiment, a syringe pump is a pump attached to the syringe. In one embodiment, a syringe pump comprises a pump and a syringe. In one embodiment, the syringe comprises a plunger, a barrel and a nozzle such that the nozzle is attached to the barrel. In one embodiment the syringe requires no needle. In one embodiment, the syringe further comprises a plunger, plunger seal, plunger flange and barrel flange. In one embodiment the means to feed epoxy solution is connected to any relevant part of the system which results in the ejection of the electrospinning epoxy solution e.g., the syringe/barrel/plunger. In one embodiment, the pump acts on the syringe plunger. In one embodiment, the pump pushes the syringe plunger. In one embodiment, the syringe comprises a needle. In one embodiment the means to feed the epoxy solution comprises any machine which pumps, ejects, pushes or delivers liquid at a particular rate. In one embodiment the means to feed the epoxy solution comprises manually pressing the plunger. As stated herein, particular parameters such as the needle parameters, inner diameter, feeding rate and solution flow rate are optimized for any particular epoxy solution composition; all is of which are within the scope of the presently disclosed subject matter.

In some embodiments more than one syringe is used for electrospinning. In some embodiments the needle is angled upwards or downwards to control the trajectory or direction of the epoxy solution jet. In some embodiments the needle is angled upwards or downwards to control the trajectory and direction of the epoxy solution jet. In some embodiments the needle is angled upwards or downwards to control the trajectory and/or direction of the epoxy solution jet. In some embodiments, as environmental conditions change, the trajectory of the needle can be varied to ensure a particular trajectory length. In one embodiment the needle comprises metal. In one embodiment the needle is connected to a grounding cable. In one embodiment the nozzle is connected to a grounding cable. In one embodiment the electrode is placed at the same height as the grounded needle. In one embodiment the electrode is placed at the same height as the grounded nozzle. In other embodiments the electrode is not placed at the same height as the grounded needle. In other embodiments the electrode is not placed at the same height as the grounded nozzle.

The power supply is configured to deliver an applied voltage according to the requirements of a particular electrospinning system. In one embodiment the power supply is connected to the electrode placed behind the fiber collector and configured to deliver an applied voltage. In one embodiment the needle and nozzle is grounded and the electrode behind the fiber collector is biased by means of the power supply. In one embodiment the needle or nozzle is grounded and the electrode behind the fiber collector is biased by means of the power supply. In one embodiment the needle or nozzle is biased by means of the power supply and the electrode behind the fiber collector is grounded. In one embodiment the needle and nozzle are biased by means of the power supply and the electrode behind the fiber collector is grounded. In one embodiment ‘biasing’ and ‘applying a voltage’ are used interchangeably. The magnitude of the applied voltage will depend on the distances between the nozzle, screen and electrode, as well as the environmental conditions and physical properties of the epoxy solution. As such, the present invention considers any magnitude of an applied voltage that facilitates electrospinning of epoxy solution into epoxy fibers. In one embodiment the distance from the nozzle to fiber collector ranges between 5 to 30 cm. In one embodiment the distance from the nozzle to fiber collector ranges between to 30 cm. In one embodiment the distance from the nozzle to fiber collector ranges between 20 to 30 cm. In one embodiment the distance from the nozzle to fiber collector ranges between 5 to 10 cm. In one embodiment the distance from the nozzle to fiber collector ranges between 10 to 20 cm.

In one embodiment the distance from the fiber collector to the electrode ranges between 0.5 to 5 cm. In one embodiment the distance from the fiber collector to the electrode ranges between 0.5 to 10 cm. In one embodiment the distance from the fiber collector to the electrode ranges between 1 to 5 cm. In one embodiment the distance from the fiber collector to the electrode ranges between 2 to 5 cm. In one embodiment the distance from the fiber collector to the electrode ranges between 3 to 5 cm. In one embodiment the distance from the fiber collector to the electrode ranges between 4 to 5 cm. In one embodiment the distance from the fiber collector to the electrode ranges between 1 to 2 cm. In one embodiment the distance from the fiber collector to the electrode ranges between 2 to 3 cm. In one embodiment the distance from the fiber collector to the electrode ranges between 3 to 4 cm. In one embodiment the distance from the fiber collector to the electrode ranges between 4 to 5 cm.

In some embodiments the applied voltage ranges between 1 to 30 kV. In some embodiments the applied voltage ranges between 1 to 5 kV. In some embodiments the applied voltage ranges between 5 to 10 kV. In some embodiments the applied voltage ranges between 10 to 20 kV. In some embodiments the applied voltage ranges between 20 to 30 kV. The applied voltage will vary according to the characteristics of each particular epoxy solution and each particular component of the electrospinning system. For example, a shorter distance between the grounded nozzle and the electrode will require a smaller applied voltage to eject epoxy solution from the nozzle in comparison with an electrode which is placed further away from the grounded nozzle. However, in some embodiments, where a less viscous solution is used, for a particular epoxy solution composition, a lower applied voltage would be required since the epoxy solution encounters less internal friction. Furthermore, since there are a number of factors which affect the required applied voltage for a particular epoxy solution, such as speed of ejected solution, cross-linking rate and a desired size for an end-product epoxy fiber, the applied voltage will be varied accordingly; all of which are considered for the present disclosure.

Curing of Fibers

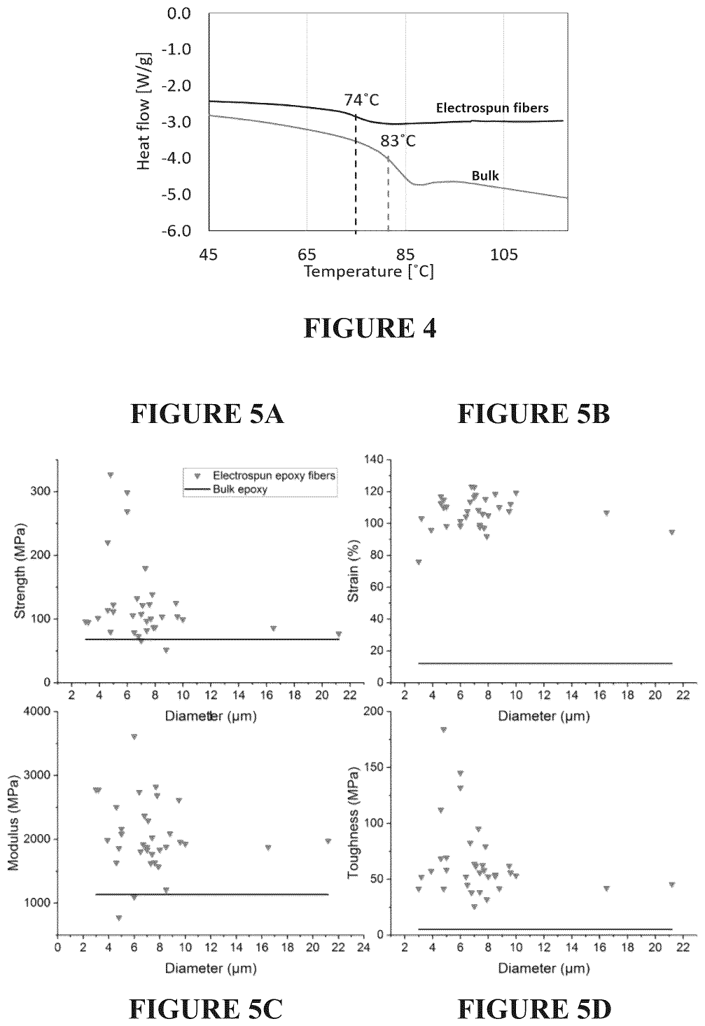

After resting on the screen, the fibers were post-cured in an oven as described herein. In some embodiments epoxy fibers do not require resting on the screen for an extended period of time before they are heat-cured. DSC analysis of the fibers was is performed and compared with the bulk epoxy. As seen in FIG. 4, no residual solvent is trapped in the fiber, as no additional endothermal peak around 79.6° C. is observed, which could have indicated evaporation of MEK. The glass transition (T_{g}) is observed at 74° C., lower than in the bulk which was 83° C. In some embodiments, depending on the composition of the epoxy solution, the glass transition temperature will vary; the electrospinning parameters are optimized accordingly. Without being bound by theory, in the process of fiber formation, two simultaneous phenomena occur: rapid evaporation of the solvent from the fiber, and reduction in polymer chain mobility and diffusion. As the fiber forms, the solvent evaporates very fast because of the high surface area to volume ratio. The epoxy groups do not diffuse fast enough to fill the gaps left by the evaporated solvent, and the result is that these remaining gaps and the unreacted epoxy terminals effectively increase the free volume and consequently reduce T_{g}.

In one embodiment, after electrospinning, epoxy fibers are left to rest for between 1 to 24 hrs. In one embodiment, after electrospinning, epoxy fibers are left to rest for between 1 to 30 hrs. In one embodiment, after electrospinning, epoxy fibers are left to rest for between 1 to 10 hrs. In one embodiment, after electrospinning, epoxy fibers are left to rest for between 5 to 10 hrs. In one embodiment, after electrospinning, epoxy fibers are left to rest for between 10 to 20 hrs. In one embodiment, after electrospinning, epoxy fibers are left to rest for between 15 to 20 hrs. In one embodiment, after electrospinning, epoxy fibers are left to rest between for 20 to 30 hrs. In one embodiment, after electrospinning, epoxy fibers are left to rest for between to 30 hrs.

In one embodiment, the epoxy fibers are placed in a vacuum for curing. In one embodiment, the epoxy fibers do not require a vacuum for curing. In one embodiment, after electrospinning, epoxy fibers are placed in a vacuum for 1 to 24 hrs. In one embodiment, after electrospinning, epoxy fibers are placed in a vacuum for 24 to 48 hrs. In one embodiment, after electrospinning, epoxy fibers are placed in a vacuum for 24 to 72 hrs. In one embodiment, after electrospinning, epoxy fibers are placed in a vacuum for 48 to 72 hrs. In one embodiment, after electrospinning, epoxy fibers are placed in a vacuum for 72 to 96 hrs. In one embodiment, after electrospinning, epoxy fibers are placed in a vacuum for 48 to 96 hrs.

In one embodiment the epoxy fibers are heat-cured. In one embodiment the epoxy fibers do not require heat-curing. In one embodiment the temperature of heat-curing of the epoxy fibers ranges between 50 to 200° C. In one embodiment the temperature of heat-curing of the epoxy fibers ranges between 50 to 100° C. In one embodiment the temperature of heat-curing of the epoxy fibers ranges between 100 to 150° C. In one embodiment the temperature of heat-curing of the epoxy fibers ranges between 150 to 200° C. In one embodiment the temperature of heat-curing of the epoxy fibers is about 100° C.

In one embodiment the duration of heat-curing of epoxy fibers ranges between 1 to 10 hours. In one embodiment the duration of heat-curing of epoxy fibers ranges between 1 to 3 hours. In one embodiment the duration of heat-curing of epoxy fibers ranges between 3 to 5 hours. In one embodiment the duration of heat-curing of epoxy fibers ranges between 5 to 7 hours. In one embodiment the duration of heat-curing of epoxy fibers ranges between 7 to 10 hours.

In one embodiment the electrospun epoxy fibers are produced by any one of the methods described herein. In one embodiment the electrospun epoxy fibers comprise an epoxy resin and an epoxy hardener. In one embodiment the electrospun epoxy fibers consist of an epoxy resin and an epoxy hardener. In some embodiments the electrospun epoxy fibers are cured. In one embodiment the electrospun epoxy fibers are not cured.

Mechanical Properties of Electrospun Epoxy Fibers

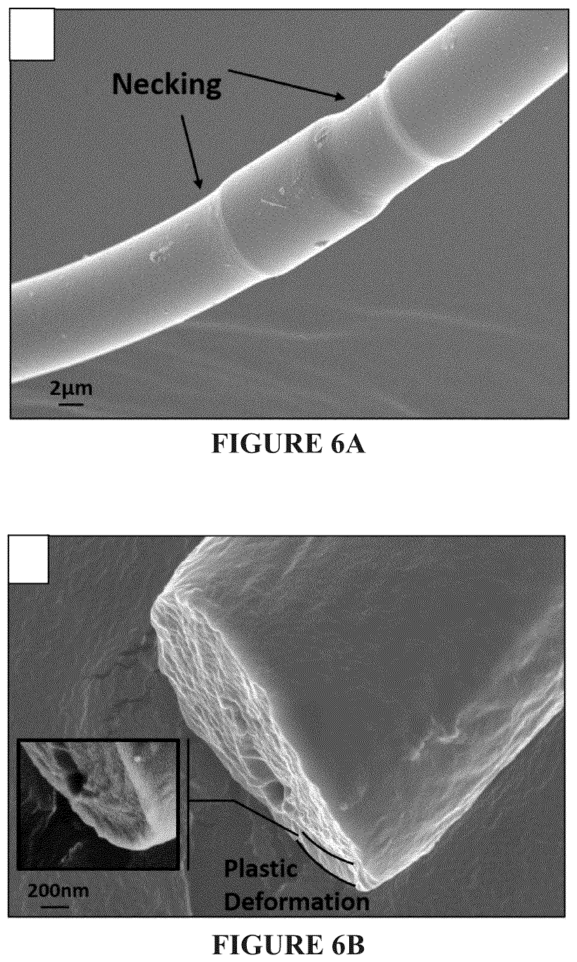

Tensile tests performed on electrospun epoxy fibers with a diameter range of 3-21 μm are presented in FIG. 5. The results for the strength, strain (maximum elongation), stiffness (Young's modulus), and effective toughness are shown against fiber diameter, and average values are presented in Table 2. The mechanical properties of the electrospun fibers are much higher than those of their counterpart bulk material, showing an average increase of 78% in strength and 83% in stiffness, as well as striking increases of 900% in strain and of 1235% in toughness. Note that the strength values are in engineering scale, calculated with the fiber cross sectional area prior to necking (FIG. 6A). In addition, because of the optical lens focus limitation, diameter measurements performed by means of an optical microscope yielded slightly larger diameters compared to the actual diameter measured by SEM. Thus, the true strength is in fact significantly higher.

In one embodiment the strength of electrospun epoxy fibers ranges between 50 and 350 MPa. In one embodiment the strength of electrospun epoxy fibers ranges is between 50 and 100 MPa. In one embodiment the strength of electrospun epoxy fibers ranges between 100 and 150 MPa. In one embodiment the strength of electrospun epoxy fibers ranges between 100 and 200 MPa. In one embodiment the strength of electrospun epoxy fibers ranges between 200 and 300 MPa. In one embodiment the strength of electrospun epoxy fibers ranges between 300 and 350 MPa.

The wide dispersion of the results is partially due to limitations of the optical inspection of the fibers before testing. Optical microscope inspection of fibers a few microns in diameter is limited to the defects one can see on the surface. Fibers with spotted defects were removed, but it was not practical to spot all the defects. A large ratio between defect size and fiber diameter can be significant when stress is applied, because it results in high stress intensity factor causing premature fracture.

The electrospinning process involves a large number of variables, including solution properties, feed rate, electric potential, environmental conditions (temperature, humidity, etc.), curing conditions and more, each with its own variability, resulting in large variability of the results. That said, the trends of the measured mechanical properties are clear, regardless of the wide dispersion. In some embodiments, each one of these parameters are optimized for electrospinning of any epoxy solution composition.

A trend of increasing strength at smaller diameters has been observed, although most of the results were obtained at around 100 MPa. The highest values are achieved for fibers with a diameter range of 5-7 μm, with a few fibers showing a particularly high strength, up to 327 MPa for a fiber with a diameter of 4.8 μm (compared to 68 MPa for bulk epoxy). For the tested range of diameters, the elastic modulus does not exhibit a similar definitive diameter-dependence trend, although the average values are around 2.0 GPa compared to just 1.1 GPa for bulk epoxy (see FIG. 5C). As used herein the terms “elastic modulus” and “Young's modulus” are used interchangeably, in some embodiments. In some embodiments the elastic modulus of electrospun epoxy fibers ranges between 0.5 to 3.5 GPa. In some embodiments the elastic modulus of electrospun epoxy fibers ranges between 0.5 to 1 GPa. In some embodiments the elastic modulus of electrospun epoxy fibers ranges between 1 to 2 GPa. In some embodiments the elastic modulus of electrospun epoxy fibers ranges between 2 to 3 GPa. In some embodiments the elastic modulus of electrospun epoxy fibers ranges between 3 to 3.5 GPa.

The strain versus diameter (FIG. 5B) shows an average relative elongation of up to 109%, but without specific correlation with the diameter. Such high elongation is uncharacteristic for epoxy, which is considered a brittle material with typical elongation of up to 12% only. In one embodiment the electrospun epoxy fiber has a diameter of about 200 nm. In some embodiments the electrospun epoxy fiber has a diameter of between 0.2 to 25 μm. In some embodiments the electrospun epoxy fiber has a diameter of between 1 to 25 μm. In some embodiments the electrospun epoxy fiber has a diameter of between 3 to 25 μm. In some embodiments the electrospun epoxy fiber has a diameter of between 3 to 21 μm. In some embodiments the electrospun epoxy fiber has a diameter of between 3 to 22 μm. In some embodiments the electrospun epoxy fiber has a diameter of between 1 to 3 μm. In some embodiments the electrospun epoxy fiber has a diameter of between 3 to 10 μm. In some embodiments the electrospun epoxy fiber has a diameter of between 10 to 20 μm. In some embodiments the electrospun epoxy fiber has a diameter of between 20 to 25 μm. In some embodiments, the diameter of the epoxy fibers refers to the diameter of epoxy fibers that have not undergone necking. In some embodiments the diameter refers to the diameter of parts of the epoxy fibers that have undergone necking. In some embodiments the diameter of the epoxy fibers changes along the length of each epoxy fiber. In some embodiments the average diameter of the epoxy fibers produced by electrospinning varies by 5%, 10%, 25% or 50% of the average value within one collection of electrospun fibers which have undergone one parameter set of electrospinning conditions. In one embodiment the diameter of epoxy fibers refers to the average or mean diameter along the length of the epoxy fiber.

In one embodiment the length of an electrospun epoxy fiber ranges between 1 mm to 1 cm. In one embodiment the length of an electrospun epoxy fiber ranges between 1 cm to 5 cm. In one embodiment the length of an electrospun epoxy fiber ranges between 5 cm to 10 cm. In one embodiment the length of an electrospun epoxy fiber ranges between 10 cm to 50 cm. In one embodiment the length of an electrospun epoxy fiber ranges between 50 cm to 100 cm. In one embodiment the length of an electrospun epoxy fiber ranges between 1 mm to 10 m.

In some embodiments the electrospun epoxy fiber has a maximum strain of between 80 to 130%. In some embodiments the electrospun epoxy fiber has a maximum strain of between 80 to 100%. In some embodiments the electrospun epoxy fiber has a maximum strain of between 100 to 120%. In some embodiments the electrospun epoxy fiber has a maximum strain of between 120 to 130%.

The toughness dependence on the diameter (FIG. 5D) shows a behavior similar to the strength (FIG. 5A). The average toughness results (Figure SD) are around 63 MPa compared to just 5.1 MPa for bulk epoxy, a consequence of the simultaneous improvement in both the strength and strain. Here also, a few particularly high data appear for toughness, reaching sometimes up to 184 MPa. As used herein the “toughness” or “effective toughness” is calculated as the area under the stress-strain curve. In some embodiments the effective toughness of electrospun epoxy fibers ranges between 25 to 200 MPa. In some embodiments the effective toughness of electrospun epoxy fibers ranges between 25 to 50 MPa. In some embodiments the effective toughness of electrospun epoxy fibers ranges between 50 to 100 MPa. In some embodiments the effective toughness of electrospun epoxy fibers ranges between 100 to 200 MPa.

SEM micrographs of fibers after tensile tests (FIG. 6A) show the formation of long necking regions in the epoxy, a common strain release mechanism that indicates substantial plastic deformation. This kind of behavior is not common in epoxy, usually characterized by rare, barely visible short necking prior to failure. The fiber cross sectional surface after failure is rough, as demonstrated in FIG. 6B. implying a ductile fracture, unlike the smooth surfaces characteristic of brittle failures, which are common in epoxy matrices. A thin sheath (about 100 nm thick) around the fiber boundary, which seems to have a different morphology than the fiber core, implies a difference in plastic flow and mechanical properties between these regions. Furthermore, a large cavity is present, possibly a crack, inside the fiber, which seems to be partially bridged by epoxy fibrils.

Comparison Between Electrospun and Drawn Epoxy Fibers

To better understand the differences between electrospun and mechanically drawn epoxy fibers, an additional group of fibers was prepared and tested. As used herein in reference to epoxy fibers, “drawn” refers to mechanically drawn fibers as opposed to those which are electrospun. These were fibers prepared from the same solution as in electrospinning but stretched by being mechanically drawn instead of electrospinning. In so doing, it is possible to separate the effects on the mechanical properties of the solution and the preparation technique. Mechanically-Drawn fibers from epoxy/MEK solution were prepared and tested as previously described (see X. M. Sui, M. Tiwari, I. Greenfeld, R. L. Khalfin, H. Meeuw, B. Fiedler, H. D. Wagner, Extreme scale-dependent tensile properties of epoxy fibers, Express Polym. Lett. 13 (11)(2019)993-1003).

The average tensile results of four groups, each over its full diameter range, are summarized in Table 2.

TABLE 2
Average tensile properties of fibers using different processing techniques.

| Processing | | Diameter | Strength | Strain | Toughness | Modulus |
|---|---|---|---|---|---|---|
| Technique | Solution | [μm] | [MPa] | (%) | [MPa] | [MPa] |
| Molding Bulk | Neat Epoxy | — | 68 | 12.1 ± 1.9 | 5.1 ± 1.1 | 1132 ± 161 |
| Drawing | Neat Epoxy | 81 ± 65 | 106 ± 35 | 116 ± 30 | 72 ± 29 | 2510 ± 601 |
| Drawing | Epoxy/MEK | 28 ± 18 | 61 ± 21 | 68 ± 28 | 29 ± 19 | 2367 ± 649 |
| Electrospinning | Epoxy/MEK | 7 ± 3 | 121 ± 64 | 109 ± 13 | 63 ± 35 | 2073 ± 566 |

As seen in Table 2, fibers produced by drawing (with or without solvent) and electrospinning yield mechanical properties—strength, strain, toughness and stiffness—that are much higher than those of neat epoxy bulk. It was also observed that the use of solvent in the processing of fibers by drawing (line 3 in Table 2, Epoxy/MEK) reduces the mechanical properties compared to drawing without solvent (line 2 in Table 2, Neat Epoxy). The reason for this is likely the lower degree of crosslinking, as shown in the DSC tests herein which leads to matrix softening and reduction in tensile mechanical properties. Lastly, the processing of fibers by electrospinning restores the average values of the properties as for fibers made by drawing of neat epoxy. However, the impact of electrospinning on the rise of the mechanical properties at small diameters is much more significant compared to drawing of neat epoxy, as further described below.

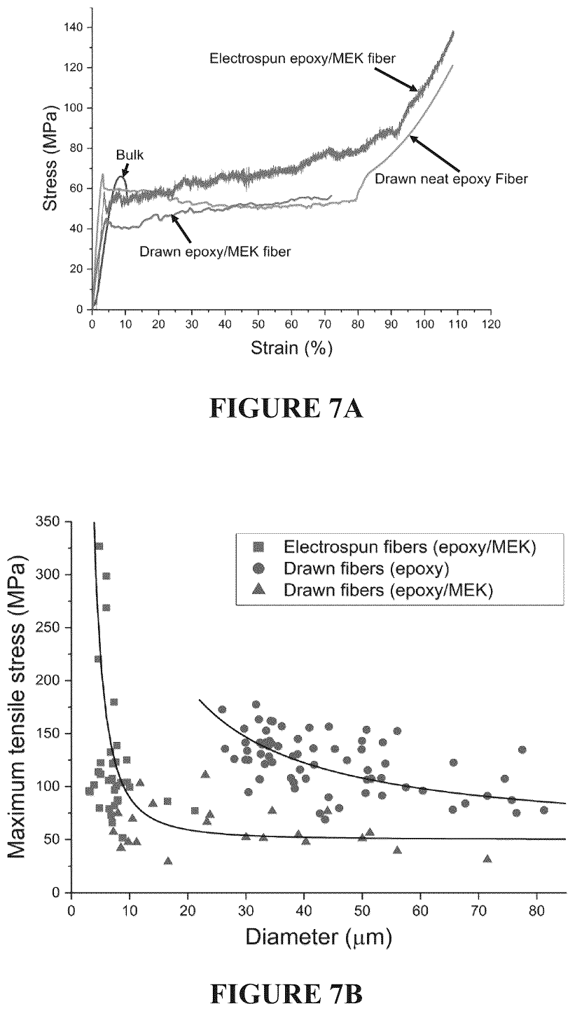

FIG. 7A presents typical stress strain curves of the three fiber types, compared to bulk epoxy. Notice the low strain to failure of the bulk dog-bone specimen, namely 12%, compared to the fibers which exhibited large plastic deformation at a fairly constant high stress up to 80% strain, followed by a stress rise until failure slightly above 100% strain. This result supports the suggestion of a low crosslinking density in the fiber matrix, as well as a preferred crosslinking direction resulting from the stretching effect, both of which may enable larger intermolecular mobility between crosslinked centers. More generally, the molecular morphology induced in a fiber stretched by drawing or electrospinning tends to be directional, such that monomers and crosslinks are partially aligned with the stretching direction (that is, fiber direction). Anisotropy was observed in epoxy fibers drawn from neat epoxy (thus, without is solvent), for which molecular orientation was measured by wide angle X-ray scattering. Similar orientation and anisotropic properties in electrospun nanofibers made of thermoplastic polymers was also observed.

FIG. 7B shows that the drawn and electrospun fibers made from the same solution of Epoxy/MEK can be regarded as one dataset, in which the drawn fibers occupy the region of large diameters, whereas the electrospun fibers occupy the region of small diameters, with an overlap at around 10 μm. The drawn neat epoxy fibers are a distinctly separate group, the strength of which rises above the bulk strength at a critical (transition) diameter around 400 μm, compared to about 80 μm in the Epoxy/MEK fibers. This large difference in critical diameters is most probably the result of the lower concentration and lower curing degree (hence lower viscosity and faster relaxation times) of the epoxy/MEK solution compared to the neat epoxy resin.

The trendlines of the strength-diameter data in FIG. 7B (solid curves) are power functions of the form σ=σ_{bulk}+aD^{b}, where σ_{bulk} is the strength of the bulk epoxy, D is the fiber diameter, and a and b are parameters fitted to the data. The power law slope (parameter b) of the steep trend line in the electrospun fibers is about −2, compared to about −1 in the drawn neat epoxy fibers, implying a stronger stretching effect owing to the electrospinning process. The power slope of −2 was also previously observed and showed that the modulus and strength are proportional to the jet strain rate (due to molecular alignment), whereas the diameter is inversely proportional to the square root of the strain rate (due to volume conservation), and therefore σ˜D⁻². The steep strength rise represented by the power law is attributed to the well-known coil stretch transition phenomenon, which causes polymer networks to sharply elongate above a critical jet strain rate. Hence, the potential of electrospinning in enhancing the mechanical properties of epoxy is high.

However, orientation effects in thermoset polymers as used in the present disclosure cannot be interpreted as in thermoplastic polymers. Measurements of drawn epoxy fibers obtained by X-ray scattering clearly point at anisotropic molecular structure along the stretching direction. A similar effect in electrospun epoxy fibers, which are subject to an even stronger stretching than drawn fibers can be found. At the molecular scale, this orientation can be reflected by the alignment of matrix crosslinking centers in the stretching direction, as well as by alignment of individual DGEBA units or of partially crosslinked DGEBA units. After fiber solidification and full curing, this alignment is translated into long necking formation as shown in FIG. 6 and in previous studies. Furthermore, such alignment orients a higher fraction of strong covalent bonds in the stretching direction, while decreasing the fraction of weaker intermolecular bonds in that direction, resulting in higher stiffness and strength in the stretching direction. This kind of stretching and molecular orientation is higher in electrospun fibers than in drawn fibers because of the low crosslinking degree of the electrospinning solution that increases molecular mobility, a result of the solvent presence.

The present disclosure introduces electrospinning as a way for producing epoxy fibers of nanometric scale possessing supreme mechanical properties. Electrospinning of standalone epoxy fibers has not been possible so far, because of the high viscosity and reactivity of epoxy, and the fragility of the fibers. To overcome this difficulty, an electrospinning method for the production of epoxy fibers with diameters down to 3 μm was developed, as disclosed herein. To obtain electro-spinnability of epoxy, the epoxy was diluted by MEK solvent, in one example, then partially cured until the solution reached the gelation point, making the solution sufficiently liquid to flow through the nozzle and at the same time sufficiently contiguous and strong to form continuous fibers. As the epoxy fibers had to be cured following electrospinning, in one example, and in order to avoid fibers agglomeration, the fibers were collected on a metal net allowing curing and handling of individual fibers. The positive electrode was placed behind the net so that fibers could each be suspended across the gaps of the net cells.

Tensile testing of the fibers revealed much increased mechanical properties of the electrospun fibers, about 80% higher in strength and stiffness compared to bulk epoxy, and striking 900% in maximum plastic elongation and 1200% in effective toughness. The fibers exhibited a sharp rise in strength as the diameter of the fibers got smaller, roughly following a power law. These results were compared with epoxy fibers produced by mechanically drawing an epoxy gel with the without solvent, demonstrating higher strength rise for spun fibers. The change in mechanical properties is likely the result of molecular orientation of epoxy elements in the fiber direction, a consequence of the extensive stretching induced by electrospinning. Also, DSC testing showed that the T_{g} of the spun fibers was lower by 9° C., implying a lower degree of crosslinking which possibly contributed to plasticity.

### Example 1

### Materials and Methods

The epoxy used in one study was diglycidyl ether of bisphenol-A (DGEBA), resin EP828 and hardener EP304 (purchased from PolymerG, Israel); the hardener was a polyether amine with trifunctional primary amine. The epoxy resin was dissolved in a dielectric solvent, methyl ethyl ketone (MEK) (Sigma Aldrich), to form an electro-responsive solution for electrospinning.

Resin and hardener were added in a glass vial (weight ratio: 100:42), as recommended by the manufacturer. MEK was then added with a weight fraction (i.e., weight of component divided by net weight of the solution or product) of 70% of the total solution weight.

The glass vial was stirred vigorously for 20 min (THINKY conditioning mixer, series ARE-250) and for an additional 76 hrs on a magnetic hot plate at 70±10° C. and 200-250 rpm stirring rate. During heating and mixing, the viscosity of the solution gradually increased because of crosslinking until reaching the gelation point. Mixing continued until the solution started to show haziness, at which point the solution was ready to use. The appearance of haziness in the solution is an indication of the beginning of transition from gelation to vitrification of epoxy, as described in detail herein. Haziness was measured by means of UV-Visible Spectrophotometer (Cary 300 Bio) and showed total absorption at 323 nm wavelength compared to 315 nm for fresh solution see FIG. 8.

### Example 2

### Electrospinning

The homemade electrospinning system (FIG. 1) consisted of a syringe pump (Fusion 4000, Chemyx Inc.) and a DC power supply (PS/FC50R02, Glassman High Voltage, High Bridge, NJ). The nozzle included a needle with inner diameter of 0.83 mm (21 gauge) connected to a disposable syringe. The fiber collector was an aluminum net with a 15×15 mm² cell size. A power supply unit was connected to a copper rod electrode 100 mm in length and 2 mm in diameter, located 10 mm behind the net. The process was conducted at room temperature, using a solution feeding rate of 0.7 ml/h and an applied voltage of 19-21 kV. Fibers accumulated on the metal net, then were left to rest for 16 h and vacuumed for another 24 h and cured in an oven at 100° C. for 6 h.

### Example 3

### Differential Scanning Calorimetry (DSC)

In order to identify full curing and perceive any solvent residuals in the matrix, the thermal behavior of the epoxy samples was monitored by differential scanning calorimetry (DSC, TA DSC Q200). Samples were placed in a hermetically sealed aluminum pan. Measurements were carried out in N₂ atmosphere from room temperature to 120° C., at a heating rate of 10° C./min⁻¹.

### Example 4

### Tensile Testing

The fibers were prepared with a gauge length of 10 mm. Prior to testing, each fiber diameter was measured under an optical microscope at 3 points along the fiber and averaged. The optical microscope was Nikon OPTIPHOT-2 connected to an IDS UI-5580CP-C-OH camera mounted on a Nikon TV lens C-0.45×. The cardboard frame supporting the fiber was connected to the load cell via a pair of fiber clamps. Prior to testing, the side edges of the cardboard frame were cut out. Mechanical tests were conducted with an Instron 5965 universal testing system (UK) equipped with a 10 N load cell, at a rate of 1 mm/min.

In one embodiment, the term “a” or “one” or “an” refers to at least one. In one embodiment the phrase “two or more” may be of any denomination, which will suit a particular purpose. In one embodiment, “about” or “approximately” may comprise a deviance from the indicated term of +1%, or in some embodiments, −1%, or in some embodiments, ±2.5%, or in some embodiments, ±5%, or in some embodiments, ±7.5%, or in some embodiments, ±10%, or in some embodiments, ±15%, or in some embodiments, ±20%, or in some embodiments, ±25%.

Those skilled in the art to which this invention pertains will readily appreciate that numerous changes, variations, and modifications can be made without departing from the scope of the presently disclosed subject matter, mutatis mutandis.

1. A method of producing an electrospinning epoxy solution, said method comprising:
mixing an epoxy resin with an epoxy hardener, producing an epoxy;
adding a dielectric solvent to said epoxy, producing an epoxy solution; and
stirring said epoxy solution to produce an electrospinning epoxy solution.

2. The method of claim 1 wherein said epoxy resin is selected from a group comprising: bisphenol-based resins, novolaks-based resins, aliphatic-based resins, halogenated resins, glycidylamine-based resins or combinations thereof.

3. The method of claim 1 wherein said dielectric solvent comprises methyl ethyl ketone (MEK), dimethylformamide (DMF), tetrahydrofuran (THF) or any combination thereof.

4. The method of claim 1 wherein the weight fraction of said dielectric solvent ranges between 50%-99% of the total solution weight.

5. The method of claim 1 wherein said stirring comprises a first stage and a second stage, wherein:
the stirring rate of said first stage is higher than the stirring rate of said second stage; or
the duration of stirring in said first stage is shorter than the duration of the stirring in said second stage; or
the temperature of said epoxy solution during said first stage is lower than the temperature of said epoxy solution during said second stage; or any combination thereof.

6. The method of claim 5 wherein the stirring rate of said first stage ranges between 500 to 2000 rpm and the stirring rate of said second stage ranges between 100-500 rpm.

7. The method of claim 5 wherein said duration of stirring in said first stage ranges between 1 minute to 1 hour and the said duration of stirring in said second stage ranges between 1 hour and 15 days.

8. The method of claim 5 wherein said temperature during said first stage is about room temperature and wherein said temperature during said second stage ranges between 50-150° C.

9. The method of claim 1 wherein said stirring stops when said epoxy solution reaches a state between pre-gelation and vitrification, producing an electrospinning epoxy solution.

10. An electrospinning epoxy solution produced by the method of claim 1.

11. A system for electrospinning epoxy fibers, said system comprising:
a syringe barrel, said barrel being at least partially filled with the electrospinning epoxy solution of claim 10;
an electrically grounded nozzle;
a needle;
a syringe pump for feeding said electrospinning epoxy solution out of said needle;
a fiber collector;
an electrode positioned behind said fiber collector; and
a power supply;
wherein said syringe pump is configured to eject said electrospinning epoxy solution from said needle when applying a voltage between said nozzle and said electrode, producing epoxy fibers which collect on said fiber collector.

12. The system of claim 11 wherein the inner diameter of said needle ranges between 0.5 to 1 mm.

13. The system of claim 11 wherein said fiber collector is made of a metal mesh.

14. The system of claim 11 wherein the distance from said nozzle to said fiber collector ranges between 5 to 30 cm and the distance from said fiber collector to said electrode ranges between 0.5 to 5 cm.

15. A method of producing epoxy fibers, said method comprising:
providing the system of claim 11;
applying a voltage between said grounded nozzle and said electrode resulting in said electrospinning epoxy solution exiting through said nozzle producing an airborne jet which lands on said fiber collector producing epoxy fibers.

16. The method of claim 15 wherein the feed rate of said electrospinning epoxy solution ranges between 0.1 to 10 ml/hr.

17. The method of claim 15 wherein said applied voltage ranges between 1 to 30 kV.

18. The method of claim 15 further comprising curing said epoxy fibers, said curing comprising:
leaving said epoxy fibers to rest for a duration of between 1 to 24 hrs after they are produced;
placing said epoxy fibers under vacuum for a duration of between 24 to 72 hrs;
placing said epoxy fibers in an oven at a temperature of between 50 to 200° C. for between 1 to 10 hrs;
or any combination thereof.

19. An electrospun epoxy fiber produced by the method of claim 15.

20. An electrospun epoxy fiber comprising:
an epoxy resin; and
an epoxy hardener;

21. The electrospun epoxy fiber of claim 20 wherein the diameter of said electrospun epoxy fiber ranges between about 200 nm to 25 μm.

22. The electrospun epoxy fiber of claim 20 wherein the length of said electrospun epoxy fiber ranges between 1 mm and 10 m.

23. The electrospun epoxy fiber of claim 20 wherein the strength of said electrospun epoxy fiber ranges between 50 to 350 MPa.

24. The electrospun epoxy fiber claim 20 wherein the maximum strain of said electrospun epoxy fiber ranges between 80 to 130%.

25. The electrospun epoxy fiber of claim 20 wherein the Young's Modulus of said electrospun epoxy fiber ranges between 1000 to 3500 MPa.

26. The electrospun epoxy fiber of claim 20 wherein the effective toughness of said electrospun epoxy fiber ranges between 25 to 200 MPa.
